(19) United States
(12) Patent Application Publication
(10) Pub. No.: US 2025/0117838 A1
(43) Pub. Date: Apr. 10, 2025

(54) Machine Learning Based Spend Classification Using Hallucinations

(71) Applicant: Oracle International Corporation, Redwood Shores, CA (US)

(72) Inventors: Akash BAVISKAR, Dist Jalgaon (IN); Krishnan RAMANATHAN, Kadubeesanahalli (IN); Vikas AGRAWAL, Hyderabad (IN); Dipawesh PAWAR, Dhule (IN)

(21) Appl. No.: 18/422,321

(22) Filed: Jan. 25, 2024

(30) Foreign Application Priority Data
Oct. 9, 2023 (IN) 202341067665

(51) Int. Cl. G06Q 30/0601

(52) U.S. Cl. CPC G06Q 30/0625

(57) ABSTRACT

Embodiments classify a product to one of a plurality of product classifications. Embodiments receive a description of the product and create a first prompt for a trained large language model (“LLM”), the first prompt including the description of the product and contextual information of the product. In response to the first prompt, embodiments use the trained LLM to generate a hallucinated product classification for the product. Embodiments word embed the hallucinated product classification and the plurality of product classifications and similarity match the embedded hallucinated product classification with one of the embedded plurality of product classifications. The matched one of the embedded plurality of product classifications is determined to be a predicted classification of the product.

One embodiment is directed generally to a computer system, and in particular to spend classification using a computer system.

### BACKGROUND INFORMATION

Spend classification is the process of assigning a category to different items and services bought for a business or other entity. All businesses engage in some form of spend management activities, intended to improve purchasing costs and lower supply base risk through the efficient use of a limited set of resources. The effectiveness of these types of activities are directly linked to the quality of the spend analytics available to the organization. Unless a business has a clear picture of what it is buying and from whom these goods and services are sourced, it will only be able to make marginal improvements to its spend performance.

Even for organizations with a high degree of control over the buying activity carried out across their business, effective analysis of spending patterns can often be challenging due to poor or inconsistent classification of all of the various transactions. Without accurate categorization of data for past spending activity, no amount of analysis can yield the information necessary to fully optimize sourcing decisions, assess the supply base and conduct effective negotiations. For organizations with lower levels of spending control, these issues are only exacerbated.

In general, spend activity for an organization will be tracked unevenly across spend categories through a variety of requisitions, purchase orders, receipts, invoices, and expenses. Even where all of these transactions are utilized aggressively and processed through the same system, ensuring that category coding is consistently applied is a constant challenge due to patchwork catalogs, compliance hiccups, and user fatigue. Even for regular and repeatable purchasing activity that is automated by contract agreement, there may still be circumstances that require occasional one-off ordering that ends up being wrongly categorized or might only be handled through additional unmatched invoices.

With ad hoc spending needs, requesters rarely know how to categorize their purchases, which can result in significant transactions being processed as general or miscellaneous spending. In circumstances where a requester or buyer does try to code an item of spending, they may face multiple similar choices and pick the incorrect category. For example, in classifying installing electric vehicle (“EV”) charging points, is the correct category (Facilities) Maintenance, (Facilities) Hardware, or (Energy) Electricity?

Ensuring accurate spend classification is made more challenging by continually evolving organizational spend patterns that regularly see categories becoming less significant or obsolete and new categories appearing to replace them. Often, these changes only become apparent well after the business shift in spending has occurred, requiring historic spend details to be reclassified against an updated category taxonomy. The same type of challenge can exist with spend analysis activities, with senior management personnel changes leading to changes in analysis requirements and reporting structures.

Unless these categorization problems are resolved, spend analysis will be flawed. Spending patterns will be misrepresented, with spend data being spread inaccurately across different categories, making it difficult for managers to monitor trends, identify sourcing opportunities and negotiate more effectively with their supply base.

### SUMMARY

Embodiments classify a product to one of a plurality of product classifications. Embodiments receive a description of the product and create a first prompt for a trained large language model (“LLM”), the first prompt including the description of the product and contextual information of the product. In response to the first prompt, embodiments use the trained LLM to generate a hallucinated product classification for the product. Embodiments word embed the hallucinated product classification and the plurality of product classifications and similarity match the embedded hallucinated product classification with one of the embedded plurality of product classifications. The matched one of the embedded plurality of product classifications is determined to be a predicted classification of the product.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates an example of a system that includes a spend classification system in accordance to embodiments.

FIG. 2 is a block diagram of the spend classification system of FIG. 1 in the form of a computer server/system in accordance to an embodiment of the present invention.

FIG. 3 is a flow/block diagram of the functionality of the spend classification module of FIG. 2 for performing spend classification in accordance with an embodiment.

FIG. 4 illustrates an example UNSPSC category hierarchy.

FIG. 5 is a flow/block diagram of the functionality of the spend classification module of FIG. 2 for performing spend classification in accordance with an embodiment.

FIG. 6 is a flow/block diagram of the functionality of the spend classification module of FIG. 2 for performing spend classification in accordance with an embodiment.

FIGS. 7-11 illustrate an example data analytics environment in accordance with an embodiment.

### DETAILED DESCRIPTION

One embodiment is a cloud based system that used large language model machine learning to generate hallucinations that are then used to accurately and efficiently assign spend classification categories to different items and services. Embodiments automatically map a product or service name to its correct category. “Product” used herein also includes services.

Spend classification provides a clear visualization on the spends of an organization and gives the opportunity to optimize the spends. Further, spend classification helps to understand risks, creates transparency in the process, increases cost awareness and promotes efficient use of resources.

Known approaches for automated spend classification generally rely on supervised machine learning algorithms. However, the drawback of supervised algorithms is that labelled data is needed for model training. Further, manually creating labelled data for any classification problem with a very high number of classes is infeasible. In contrast, spend classification in accordance to embodiments primarily uses hallucinations generated by a large language model (“LLM”) and then further classification to avoid the need for labelled data and improve accuracy.

Reference will now be made in detail to the embodiments of the present disclosure, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

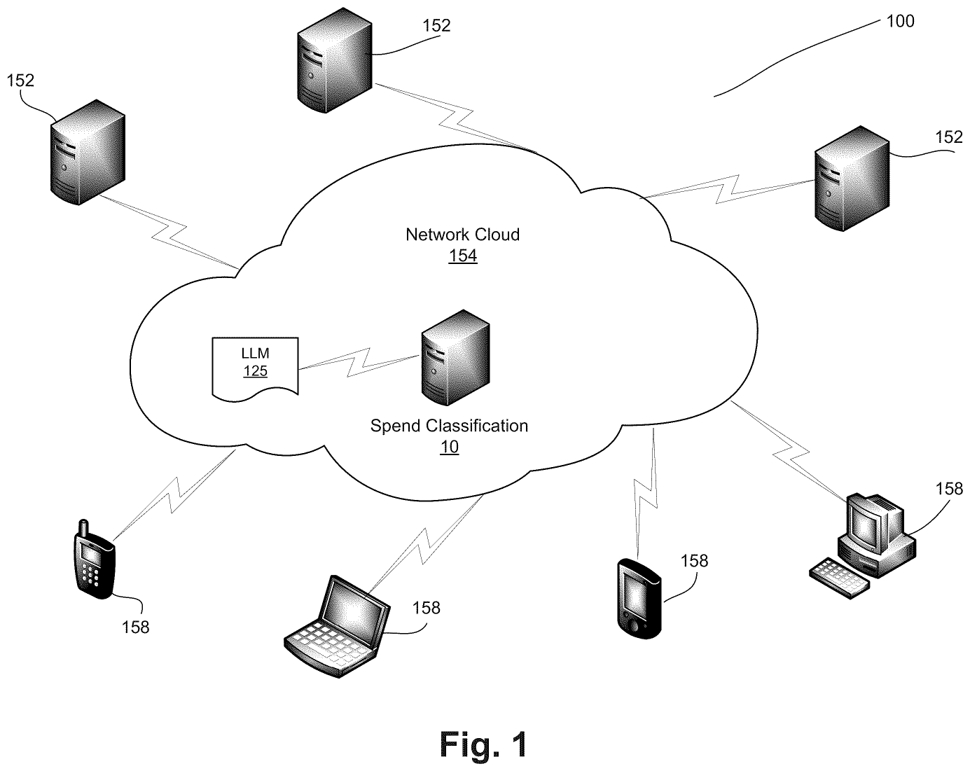

FIG. 1 illustrates an example of a system 100 that includes a spend classification system 10 in accordance to embodiments. Spend classification system 10 may be implemented within a computing environment that includes a communication network/cloud 154. Network 154 may be a private network that can communicate with a public network (e.g., the Internet) to access additional services 152 provided by a cloud services provider. Examples of communication networks include a mobile network, a wireless network, a cellular network, a local area network (“LAN”), a wide area network (“WAN”), other wireless communication networks, or combinations of these and other networks. Spend classification system 10 may be administered by a service provider, such as via the Oracle Cloud Infrastructure (“OCI”) from Oracle Corp.

Tenants of the cloud services provider can be companies or any type of organization or groups whose members include users of services offered by the service provider. Services may include or be provided as access to, without limitation, an application, a resource, a file, a document, data, media, or combinations thereof. Users may have individual accounts with the service provider and organizations may have enterprise accounts with the service provider, where an enterprise account encompasses or aggregates a number of individual user accounts.

System 100 further includes client devices 158, which can be any type of device that can access network 154 and can obtain the benefits of the functionality of spend classification system 10 of classifying spending. As disclosed herein, a “client” (also disclosed as a “client system” or a “client device”) may be a device or an application executing on a device. System 100 includes a number of different types of client devices 158 that each is able to communicate with network 154.

Executing on cloud 154 is at least one LLM 125. An LLM is a type of artificial intelligence (“AI”) model that is trained on a massive amount of text data. An LLM can generate text, translate text from one language to another, write different kinds of creative content, and answer questions in an informative way. In general, an LLM is a machine that has been taught to understand and use language the way that humans do. An LLM can read and write, and can understand and respond to complex questions. Examples of LLMs that can be used in embodiments include “ChatGPT”, “Bard AI”, and various opens source LLMs. Embodiments can be implemented with any sufficiently large LLM. However, LLMs trained with domain specific data can provide more accurate results.

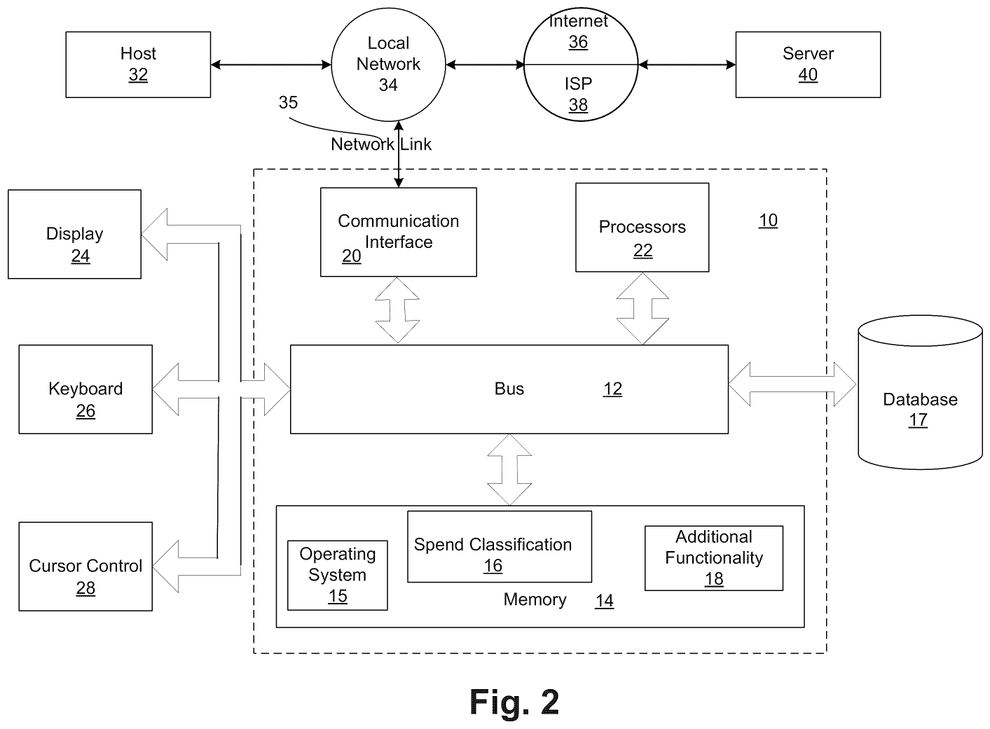

FIG. 2 is a block diagram of spend classification system 10 of FIG. 1 in the form of a computer server/system 10 in accordance to an embodiment of the present invention. Although shown as a single system, the functionality of system 10 can be implemented as a distributed system. Further, the functionality disclosed herein can be implemented on separate servers or devices that may be coupled together over a network. Further, one or more components of system 10 may not be included. One or more components of FIG. 2 can also be used to implement any of the elements of FIG. 1.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication interface 20, such as a network interface card, to provide access to a network. Therefore, a user may interface with system 10 directly, or remotely through a network, or any other method.

Computer readable media may be any available media that can be accessed by processor 22 and includes both volatile and nonvolatile media, removable and non-removable media, and communication media. Communication media may include computer readable instructions, data structures, program modules, or other data in a modulated data signal such as a carrier wave or other transport mechanism, and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include a spend classification module 16 that classifies spending, and all other functionality disclosed herein. System 10 can be part of a larger system. Therefore, system 10 can include one or more additional functional modules 18, such as a business intelligence or data warehouse application (e.g., “Procurement and Spend Analytics” from Oracle Corp.) that utilizes the spend classification functionality. A file storage device or database 17 is coupled to bus 12 to provide centralized storage for modules 16 and 18, including training data used to generate the ML models. In one embodiment, database 17 is a relational database management system (“RDBMS”) that can use Structured Query Language (“SQL”) to manage the stored data.

In embodiments, communication interface 20 provides a two-way data communication coupling to a network link 35 that is connected to a local network 34. For example, communication interface 20 may be an integrated services digital network (“ISDN”) card, cable modem, satellite modem, or a modem to provide a data communication connection to a corresponding type of telephone line or Ethernet. As another example, communication interface 20 may be a local area network (“LAN”) card to provide a data communication connection to a compatible LAN. Wireless links may also be implemented. In any such implementation, communication interface 20 sends and receives electrical, electromagnetic or optical signals that carry digital data streams representing various types of information.

Network link 35 typically provides data communication through one or more networks to other data devices. For example, network link 35 may provide a connection through local network 34 to a host computer 32 or to data equipment operated by an Internet Service Provider (“ISP”) 38. ISP 38 in turn provides data communication services through the Internet 36. Local network 34 and Internet 36 both use electrical, electromagnetic or optical signals that carry digital data streams. The signals through the various networks and the signals on network link 35 and through communication interface 20, which carry the digital data to and from computer system 10, are example forms of transmission media.

System 10 can send messages and receive data, including program code, through the network(s), network link 35 and communication interface 20. In the Internet example, a server 40 might transmit a requested code for an application program through Internet 36, ISP 38, local network 34 and communication interface 20. The received code may be executed by processor 22 as it is received, and/or stored in database 17, or other non-volatile storage for later execution.

In one embodiment, system 10 is a computing/data processing system including an application or collection of distributed applications for enterprise organizations, and may also implement logistics, manufacturing, and inventory management functionality. The applications and computing system 10 may be configured to operate locally or be implemented as a cloud-based networking system, for example in an infrastructure-as-a-service (“IAAS”), platform-as-a-service (“PAAS”), software-as-a-service (“SAAS”) architecture, or other type of computing solution.

### Classifier 1

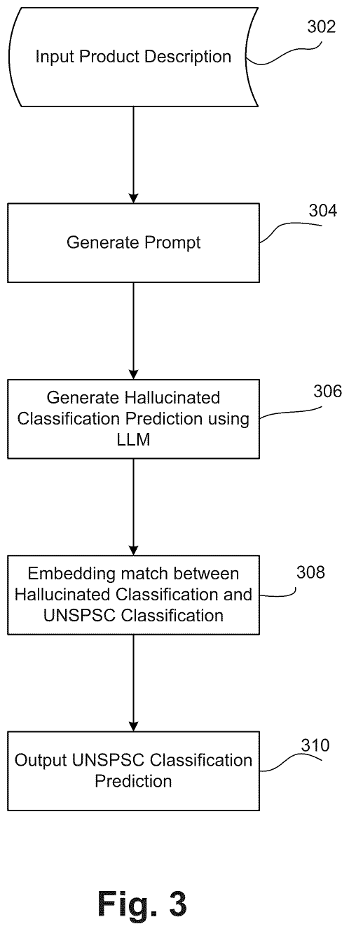

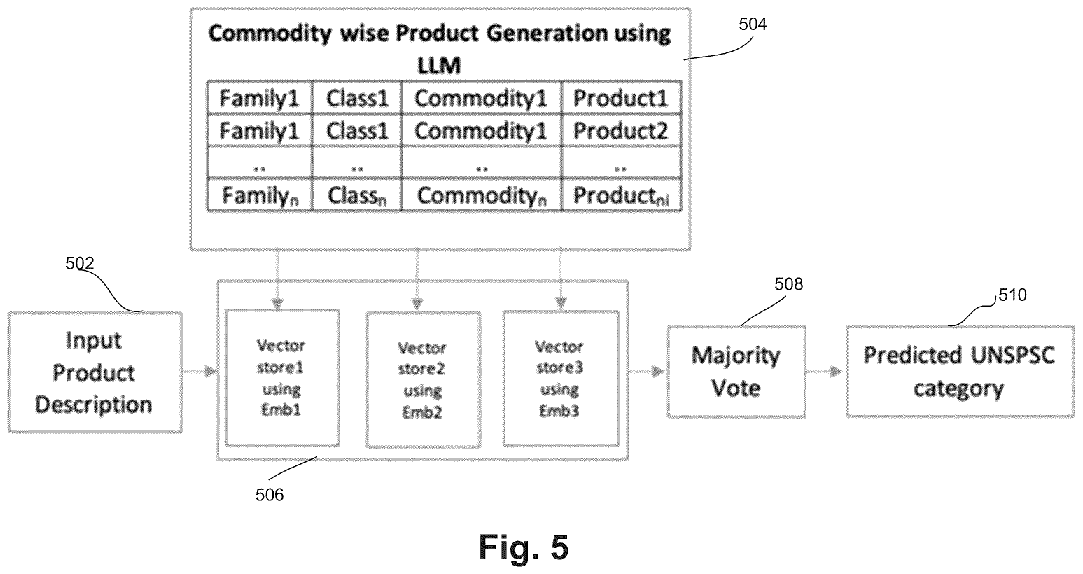

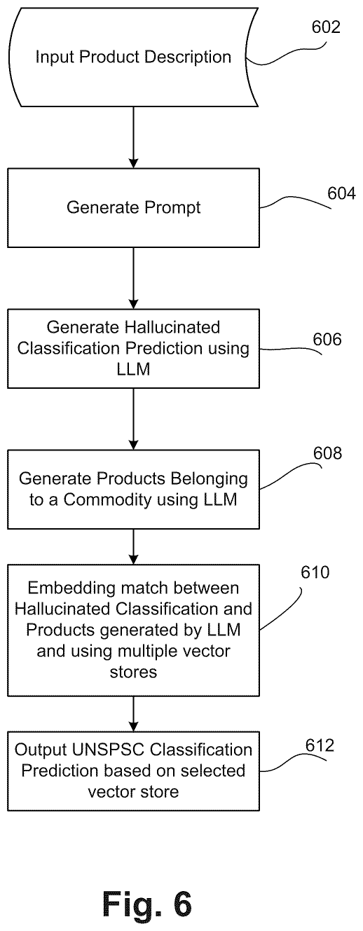

FIG. 3 is a flow/block diagram of the functionality of spend classification module 16 of FIG. 2 for performing spend classification in accordance with an embodiment. The functionality of FIG. 3 assigns a United Nations Standard Products and Services Code (“UNSPSC”) category to items and services bought based on their textual description. In one embodiment, the functionality of the flow diagram of FIG. 3 (and FIGS. 5 and 6 below) is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

Embodiments utilize a predefined definition listing of all possible spend categories. In one embodiment, UNSPSC taxonomy is used to define all possible spend categories (also referred to as “commodities”). In other embodiments, any proprietary or public taxonomy may be used. The UNSPSC is a taxonomy of products and services for use in eCommerce. It is a four-level hierarchy coded as an eight-digit number, with an optional fifth level adding two more digits. Table 1 below shows the number of distinct categories for each of the four required levels of the UNSPSC:

TABLE 1

| UNSPSC | Number of |
|---|---|
| Taxonomy Level | distinct categories |
| Segment | 57 |
| Family | 465 |
| Class | 5313 |
| Commodity/Category | 71502 |

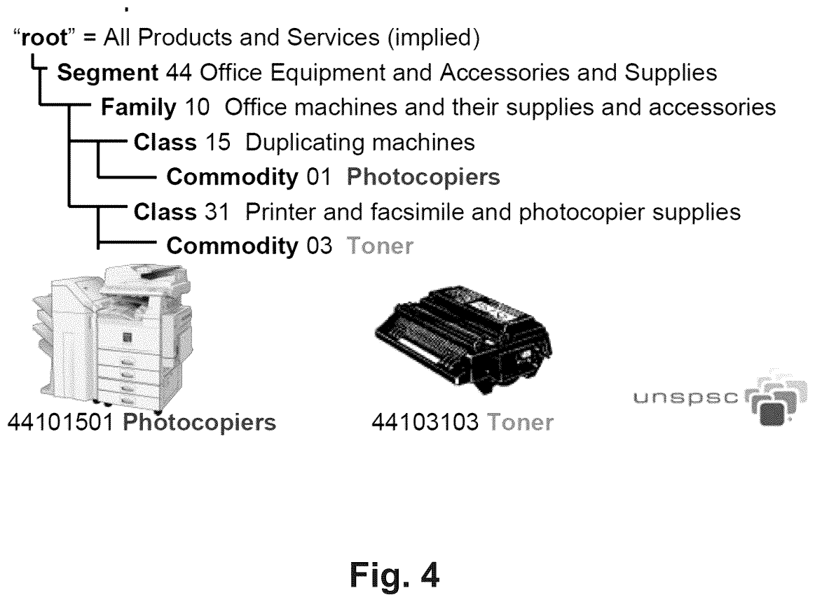

Given an inputted textual description of an item purchased, embodiments use a combination of an LLM and embedding similarity matching to classify the item into a predefined set of categories. Embodiments classify at the UNSPSC commodity level shown in Table 1 above, which includes 71502 total distinct categories. In general, embodiments solve a text classification problem with 71502 categories/classes. FIG. 4 illustrates an example UNSPSC category hierarchy.

Referring again to FIG. 3, at 302, a textual input description of the product is received. An example input description can be text such as “2405 Liko Large Blue Aluminum Lined Finger Support.” In some embodiments, multiple text fields or descriptions may be concatenated followed by preprocessing for removing distracting items such as numbers, brand names, places, colors, materials, elements, etc. In embodiments, the input description can be directly obtained, via a query, from a product database without user intervention.

At 304, a prompt is created for the LLM. Prompt creation, in general, is the process of structuring text that can be interpreted and understood by a generative AI model. A prompt is natural language text describing the task that an AI should perform. For a given input textual product description at 302, embodiments create a prompt for the LLM by mentioning the contextual information of the product. Instead of just mentioning the product's textual description, the prompt provide more context, which helps the LLM understand the product better and improves accuracy. Embodiments can generate follow up prompts based on output closeness to some category in the taxonomy, in order to broaden the search where obscure items are encountered.

The prompt created at 304 in embodiments includes one or more of:
Product Description;
Price;
Enterprise details;
Department purchasing the product;
Manufacturer name;
Country of manufacture.

In one embodiment, the format of the prompt at 304 is the following as a single prompt. The text of the non-input portion (i.e., not in the brackets) can be completely changed based on specific use cases, and serve as a template within the context of a use case. The input portion, between the brackets, are provided by the input description at 302, such as from a database table where the specific bracketed portions are specified, or may be extracted from an unstructured text. In some embodiments, users may manually provide the input portions in order to get classifications from the system.
{product_name} has been purchased by {company_name}.
{company_name} belongs to {industry_name}.
{company_name} specializes in {company_area_of_business}.
The purchase order was placed by {department_name} of the company.
The approximate cost of {product_name} is {cost}.
The {product_name} is manufactured in {manufacture_country} by {manufacturer_name}.
What is the UNSPSC classification of {product_name}? Please provide UNSPSC family, class, and category.

In the above prompt, the product_name, company_name, department_name, cost, manufacture_country, and manufacturer_name are generally expected to be provided as inputs from the customer's database. However, industry_name and company_area_of_business may sometimes not be available as an input at 302 (i.e., not stored in product database or known by the user). Therefore, in embodiments, industry_name and company_area_of_business may be inferred using an LLM based on company_name or using the list of products on which the company has spent the most using the following prompts:

The name of the industry may be inferred by the LLM from the name of the company using the following prompt:
Please provide the industry for {company_name}.

By comparing the list of items and services that a company has spent the most on to the list of items and services that are typically spent the most on in different industries, it is possible to determine the industry that the company belongs to. For example, if a company has spent the most on raw materials and labor, it is likely to be a manufacturing company. If a company has spent the most money on marketing and sales, it is likely to be a service company. Therefore, the following prompt may be used to infer the industry name using the list of products on which the company has spent most, which generally are directly available from the company's database:
Here is the list of products on which the company has spent most in the recent past: {list_of_products_on_which_company_has_spent_most}. Please provide the industry name this company belongs to.

The company's area of business may be inferred using the name of the company with the following prompt:
Please provide the company area of business for {company_name}.

At 306, the prompt or prompts created at 304 are used to query the LLM. to get the UNSPSC classification. In response, the LLM responds with a hallucinated UNSPSC classification. In general, the family, class and category returned by LLM do not actually exist (i.e., hallucinated). While in some instances the LLM may output actual real classifications, in general these are not reported to the end user without 308 being implemented.

The family, class and category returned by the LLM do not actually exist, or likely do not exist, but they generally have the same semantic meaning as the actual UNSPSC family, class and category. Therefore, at 308, embodiments use embedding matching to map the hallucinated family, class and category from 306 with an actual set of 71502 UNSPSC categories.

In general, a word embedding is a representation of a word. The embedding is used in text analysis. Typically, the representation is a real-valued vector that encodes the meaning of the word or words in such a way that the words that are closer to the vector space are expected to be similar in meaning, using a calculated similarity index between two words or group of words, “x” and “y”.

In some embodiments, the determining the similarity index includes calculating a cosine similarity index as: Cos(x, y)=x·y/∥x∥*∥y∥, where “x·y” is a product (dot) of a vector x and a vector y, ∥x∥ is a length of the vector x, ∥y∥is a length of the vector y, ∥x∥*∥y∥ is a crossproduct of the vector x and the vector y, the vector x represents embeddings of the hallucinated classification, and the vector y represents embeddings of the UNSPSC classifications.

Embodiments concatenate the hallucinated family, class and category from 306 to form the string x. Embodiments represent each category in the actual set of 71502 UNSPSC categories by concatenating the actual family, class and category into the string y. Embodiments then map the hallucinated family, class and category to the actual family, class, and category having the best embedding similarity to get the final prediction. The category from the UNSPSC taxonomy that has the highest similarity score with the output at 306, such as the cosine similarity, is chosen as the recommended spend classification to the customer in embodiments.

At 310, the final prediction of the UNSPSC classification (i.e., prediction of the family, class and category) is output.

As an example of the functionality of FIG. 3, an example of a complete set of prompts generated at 304 are as follows:
A product named ‘¼″ PARA Inline Relief Valve—165 Psi 222-3847338’ has been purchased by company named ‘ABC Fire Fighting company’.
‘ABC Fire Fighting company’ belongs to ‘Fire Equipment and Services’ industry.
‘ABC Fire Fighting company’ specializes in ‘providing emergency responder equipment’.
The purchase order was placed by ‘Product Department’ of the company.
Approximate cost of the ‘¼″ PARA Inline Relief Valve—165 Psi 222-3847338’ is 208 US dollars.
‘¼″ PARA Inline Relief Valve—165 Psi 222-3847338’ is manufactured in South Korea by ‘PARATECH Industrial valve manufacturing company’. What is UNSPSC classification of this product? Please provide UNSPSC Family, Class and Category.

The hallucinated classification generated at 306 in the example is as follows:
Family: Valves
Class: Inline Relief Valves
Category: Pressure Relief Valves

As a result of the embedding match at 308, the actual UNSPSC prediction generated at 310 is as follows:
Family: Fluid and gas distribution
Class: Valves
Category: Relief Valves

### Classifier 2

Known spend classification solutions that only use an embedding matching approach (i.e., without first using an LLM to generate an hallucinated classification as disclosed above in conjunction with FIG. 3) sometime fall short due to multiple reasons, such as the granularity at which categories/commodities are defined in the UNSPSC hierarchy or due to the limitations of embedding. As one example, the input product “Airline track black” is mapped with the category “Lighting Fixtures and Accessories, Interior Lighting Fixtures and Accessories, Track Lighting,” using only embedding matching, while the correct match should have been “Hardware, Anchors, Tie Down Anchors”.

In order to address this issue of granularity of commodity/category defined in the UNSPSC hierarchy, embodiments add a more granular layer of the products belonging to each commodity. Embodiments use an LLM to generate all products belonging to each commodity in the UNSPSC hierarchy. Then, instead of matching the embedding of the input product description with the 71502 UNSPSC commodities, embodiments match the embedding of the input product with commodity-wise products generated with the LLM.

FIG. 5 is a flow/block diagram of the functionality of spend classification module 16 of FIG. 2 for performing spend classification in accordance with an embodiment.

At 502, an input product description is received.

At 504, an LLM is used to generate all products belonging to a commodity in response to a prompt. In embodiments, this is done for all UNSPSC commodities. The product description extracted from a database, including concatenation of multiple name, description and title fields, generally includes the commodity name or a close synonym. An example prompt is as follows:
You are an expert on the UNSPSC classification of products. Please return a list of all products belonging to the following UNSPSC hierarchy: {‘UNSPSC Family Name’: {Family_name}, ‘UNSPSC Class Name’: {Class_name}, ‘UNSPSC Commodity Name’: {Commodity_name}

Table 2 below is an example list of products generated for the UNSPSC hierarchy “Personal care products, Bath and body, Facial care products” using the LLM at 504:

TABLE 2

| | | | Product |
|---|---|---|---|
| | | | Generated by |
| Family | Class | Commodity | LLM |
| Personal care | Bath and body | Facial care | Cleanser |
| products | | products | |
| Personal care | Bath and body | Facial care | Moisturizer |
| products | | products | |
| Personal care | Bath and body | Facial care | Serum |
| products | | products | |
| Personal care | Bath and body | Facial care | Toner |
| products | | products | |
| Personal care | Bath and body | Facial care | Sunscreen |
| products | | products | |
| Personal care | Bath and body | Facial care | Spot treatment |
| products | | products | |
| Personal care | Bath and body | Facial care | Eye cream |
| products | | products | |
| Personal care | Bath and body | Facial care | Lip balm |
| products | | products | |
| Personal care | Bath and body | Facial care | Mask |
| products | | products | |
| Personal care | Bath and body | Facial care | Scrub |
| products | | products | |
| Personal care | Bath and body | Facial care | Exfoliator |
| products | | products | |
| Personal care | Bath and body | Facial care | Makeup remover |
| products | | products | |

Once all products belonging to each commodity in the UNSPSC hierarchy are generated at 504, at 506 embodiments store the embedding of these products (i.e., a vector corresponding to each combination of family, class, commodity/category and product) in one or more vector stores. A vector store is a database used to store vectors such that search operations on vectors work efficiently. A vector store can store vectors (i.e., fixed-length lists/arrays of numbers) along with other data items. A vector store is typically implemented using one or more Approximate Nearest Neighbor (“ANN”) algorithms or other type of algorithm, so that the vector store can be searched with a query vector to retrieve the closest matching database records.

In one embodiment, three vector stores with 3 different embeddings are implemented at 506. If the prediction made by at least 2 out of 3 vector stores match, then the final prediction at 510 is declared as per the majority vote at 506. Otherwise, the final prediction at 512 is decided based on cosine similarity scores from the 3 vector stores with the highest similarity score used as the prediction.

The benefit of using multiple vector stores created using multiple embeddings in order to encode text into vectors is to avoid overdependency on a single embedding. Different embeddings are trained on different sets of training data. As an example, assume 100 products are generated for each commodity using an LLM at 504. The result will be 71,502*100=7,150,200 total products. Now, in vector store 1, the embeddings generated for each of the 7,150,200 products are stored using the “Universal Sentence Encoder”; in vector store 2, the embeddings generated for each of the 7,150,200 products are stored using the “Word2Vec encoder”; and in vector store 3, the embeddings generated for each of the 7,150,200 products are stored using “Sentence Transformer embedding.” “Universal Sentence Encoder”, “Word2Vec”, and “Sentence Transformer embedding” are three different off-the-shelf open-source embeddings that are trained on different training data selected by their respective owners. Other types of embeddings can be used in embodiments.

Now, when a product description is classified, embodiments compare the embedding of the product description with the embeddings available in vector store 1 to get the first prediction, and similarly, compare the embedding of the product description with the embeddings available in vector stores 2 and 3 to get the second and third predictions. If the predictions made by at least 2 out of 3 vector stores match, then the final prediction at 510 is declared as per the majority vote at 508. Otherwise, the final prediction at 512 is decided based on cosine similarity scores from the 3 vector stores with the highest similarity score used as the prediction. Therefore, if one embedding fails on a particular task, another embedding may perform better on the same task.

### Classifier 3

FIG. 6 is a flow/block diagram of the functionality of spend classification module 16 of FIG. 2 for performing spend classification in accordance with an embodiment. The functionality of FIG. 6 combines the functionality of the spend classification disclosed in conjunction with both FIG. 3 and FIG. 5.

Specifically, in response to receiving a product description at 602, similar to at 302, one or more LLM prompts are generated at 604, similar to at 304. Further, predictions are generated at 606 using an LLM, similar to at 306.

At 608, products belonging to the commodity generated at 606 are generated using an LLM, similar to at 504. At 610, an embedding match is implemented between the hallucinated classification at 606 and the products generated at 608 using vector stores, similar to at 506. At 612, the UNSPSC classification is predicted using multiple vector stores, similar to at 508 and 510.

### Tagging a Purchase as Relevant/Irrelevant

In embodiments, once the industry of the company is inferred using the LLM from the prompt described above, each purchase made by the company can be determined to be relevant, or fraudulent/irrelevant. A company may belong to multiple industries. Any product that lies outside of this list can be marked as fraudulent/irrelevant and checked for any fraudulent behavior. For example, a Fire Equipment and Services company would likely not buy cosmetic products like lipstick. The following prompt can be used for determining by an LLM whether a product purchase may be fraudulent:
There is a spend of {amount} for buying {product name} at an enterprise. Given that the enterprise belongs to {industry}, do you think this is a fraudulent/irrelevant spend?

In the embodiments above, the prediction made by the LLM may be slightly different for each occurrence, even if the same prompt is used, as the training process of the LLM is stochastic. However, in embodiments, for the use case of spend classification, the classification is expected to be the same every time a prediction on a product using the same prompt is generated. This is achieved in embodiments by fixing the seed of the LLM, or setting a random seed for reproducibility. Fixing the seed ensures that if one trains or generates text using the model multiple times with the same seed, the same results will be generated each time.

### Data Analytics Environment

In one embodiment, embodiments of the invention are implemented as part of a cloud based data analytics environment. In general, data analytics enables the computer-based examination or analysis of large amounts of data, in order to derive conclusions or other information from that data; while business intelligence tools provide an organization's business users with information describing their enterprise data in a format that enables those business users to make strategic business decisions.

Examples of data analytics environments and business intelligence tools/servers include Oracle Business Intelligence Server (“OBIS”), Oracle Analytics Cloud (“OAC”), and Fusion Analytics Warehouse (“FAW”), which support features such as data mining or analytics, and analytic applications.

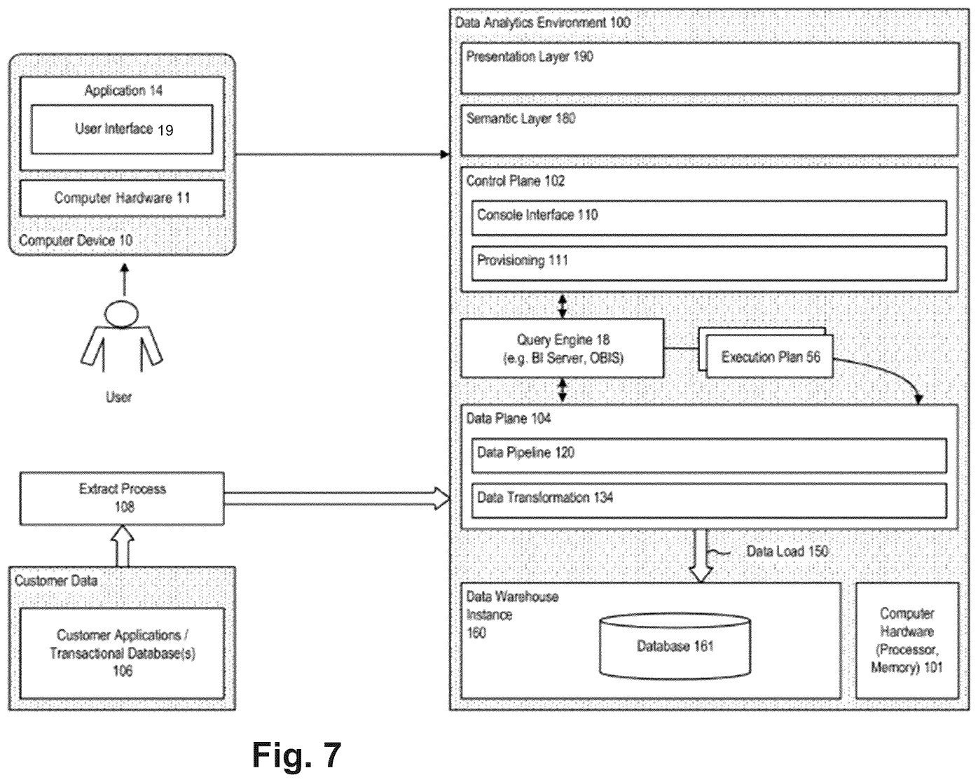

FIG. 7 illustrates an example data analytics environment, in accordance with an embodiment. The example embodiment illustrated in FIG. 7 is provided for purposes of illustrating an example of a data analytics environment in association with which various embodiments described herein can be used. In accordance with other embodiments and examples, the approach described herein can be used with other types of data analytics, database, or data warehouse environments. The components and processes illustrated in FIG. 7, and as further described herein with regard to various other embodiments, can be provided as software or program code executable by, for example, a cloud computing system, or other suitably-programmed computer system.

As illustrated in FIG. 7, in accordance with an embodiment, a data analytics environment 100 can be provided by, or otherwise operate at, a computer system having a computer hardware (e.g., processor, memory) 101, and including one or more software components operating as a control plane 102, and a data plane 104, and providing access to a data warehouse, data warehouse instance 160, database 161, or other type of data source.

In accordance with an embodiment, the control plane operates to provide control for cloud or other software products offered within the context of a SaaS or cloud environment, such as, for example, an Oracle Analytics Cloud environment, or other type of cloud environment. For example, in accordance with an embodiment, the control plane can include a console interface 110 that enables access by a customer (tenant) and/or a cloud environment having a provisioning component 111.

In accordance with an embodiment, the console interface can enable access by a customer (tenant) operating a graphical user interface (“GUI”) and/or a command-line interface (“CLI”) or other interface; and/or can include interfaces for use by providers of the SaaS or cloud environment and its customers (tenants). For example, in accordance with an embodiment, the console interface can provide interfaces that allow customers to provision services for use within their SaaS environment, and to configure those services that have been provisioned.

In accordance with an embodiment, a customer (tenant) can request the provisioning of a customer schema within the data warehouse. The customer can also supply, via the console interface, a number of attributes associated with the data warehouse instance, including required attributes (e.g., login credentials), and optional attributes (e.g., size, or speed). The provisioning component can then provision the requested data warehouse instance, including a customer schema of the data warehouse; and populate the data warehouse instance with the appropriate information supplied by the customer.

In accordance with an embodiment, the provisioning component can also be used to update or edit a data warehouse instance, and/or an extract, transform, and load (“ETL”) process that operates at the data plane, for example, by altering or updating a requested frequency of ETL process runs, for a particular customer (tenant).

In accordance with an embodiment, the data plane can include a data pipeline or process layer 120 and a data transformation layer 134, that together process operational or transactional data from an organization's enterprise software application or data environment, such as, for example, business productivity software applications provisioned in a customer's (tenant's) SaaS environment. The data pipeline or process can include various functionality that extracts transactional data from business applications and databases that are provisioned in the SaaS environment, and then load a transformed data into the data warehouse.

In accordance with an embodiment, the data transformation layer can include a data model, such as, for example, a knowledge model (“KM”), or other type of data model, that the system uses to transform the transactional data received from business applications and corresponding transactional databases provisioned in the SaaS environment, into a model format understood by the data analytics environment. The model format can be provided in any data format suited for storage in a data warehouse. In accordance with an embodiment, the data plane can also include a data and configuration user interface, and mapping and configuration database.

In accordance with an embodiment, the data plane is responsible for performing ETL operations, including extracting transactional data from an organization's enterprise software application or data environment, such as, for example, business productivity software applications and corresponding transactional databases offered in a SaaS environment, transforming the extracted data into a model format, and loading the transformed data into a customer schema of the data warehouse.

For example, in accordance with an embodiment, each customer (tenant) of the environment can be associated with their own customer tenancy within the data warehouse, that is associated with their own customer schema; and can be additionally provided with read-only access to the data analytics schema, which can be updated by a data pipeline or process, for example, an ETL process, on a periodic or other basis.

In accordance with an embodiment, a data pipeline or process can be scheduled to execute at intervals (e.g., hourly/daily/weekly) to extract transactional data from an enterprise software application or data environment, such as, for example, business productivity software applications and corresponding transactional databases 106 that are provisioned in the SaaS environment.

In accordance with an embodiment, an extract process 108 can extract the transactional data, whereupon extraction of the data pipeline or process can insert extracted data into a data staging area, which can act as a temporary staging area for the extracted data. The data quality component and data protection component can be used to ensure the integrity of the extracted data. For example, in accordance with an embodiment, the data quality component can perform validations on the extracted data while the data is temporarily held in the data staging area.

In accordance with an embodiment, when the extract process has completed its extraction, the data transformation layer can be used to begin the transform process, to transform the extracted data into a model format to be loaded into the customer schema of the data warehouse.

In accordance with an embodiment, the data pipeline or process can operate in combination with the data transformation layer to transform data into the model format. The mapping and configuration database can store metadata and data mappings that define the data model used by data transformation. The data and configuration user interface (“UI”) can facilitate access and changes to the mapping and configuration database.

In accordance with an embodiment, the data transformation layer can transform extracted data into a format suitable for loading into a customer schema of data warehouse, for example according to the data model. During the transformation, the data transformation can perform dimension generation, fact generation, and aggregate generation, as appropriate. Dimension generation can include generating dimensions or fields for loading into the data warehouse instance.

In accordance with an embodiment, after transformation of the extracted data, the data pipeline or process can execute a warehouse load procedure 150 to load the transformed data into the customer schema of the data warehouse instance. Subsequent to the loading of the transformed data into customer schema, the transformed data can be analyzed and used in a variety of additional business intelligence processes.

Different customers of a data analytics environment may have different requirements with regard to how their data is classified, aggregated, or transformed, for purposes of providing data analytics or business intelligence data, or developing software analytic applications. In accordance with an embodiment, to support such different requirements, a semantic layer 180 can include data defining a semantic model of a customer's data; which is useful in assisting users in understanding and accessing that data using commonly-understood business terms; and provide custom content to a presentation layer 190.

In accordance with an embodiment, a semantic model can be defined, for example, in an Oracle environment, as a BI Repository (“RPD”) file, having metadata that defines logical schemas, physical schemas, physical-to-logical mappings, aggregate table navigation, and/or other constructs that implement the various physical layer, business model and mapping layer, and presentation layer aspects of the semantic model.

In accordance with an embodiment, a customer may perform modifications to their data source model, to support their particular requirements, for example by adding custom facts or dimensions associated with the data stored in their data warehouse instance; and the system can extend the semantic model accordingly.

In accordance with an embodiment, the presentation layer can enable access to the data content using, for example, a software analytic application, user interface, dashboard, key performance indicators (“KPI”'s); or other type of report or interface as may be provided by products such as, for example, Oracle Analytics Cloud, or Oracle Analytics for Applications.

In accordance with an embodiment, a query engine 18 (e.g., OBIS) operates in the manner of a federated query engine to serve analytical queries within, e.g., an Oracle Analytics Cloud environment, via SQL, pushes down operations to supported databases, and translates business user queries into appropriate database-specific query languages (e.g., Oracle SQL, SQL Server SQL, DB2 SQL, or Essbase MDX). The query engine (e.g., OBIS) also supports internal execution of SQL operators that cannot be pushed down to the databases.

In accordance with an embodiment, a user/developer can interact with a client computer device 10 that includes a computer hardware 11 (e.g., processor, storage, memory), user interface 19, and application 14. A query engine or business intelligence server such as OBIS generally operates to process inbound, e.g., SQL, requests against a database model, build and execute one or more physical database queries, process the data appropriately, and then return the data in response to the request.

To accomplish this, in accordance with an embodiment, the query engine or business intelligence server can include various components or features, such as a logical or business model or metadata that describes the data available as subject areas for queries; a request generator that takes incoming queries and turns them into physical queries for use with a connected data source; and a navigator that takes the incoming query, navigates the logical model and generates those physical queries that best return the data required for a particular query.

For example, in accordance with an embodiment, a query engine or business intelligence server may employ a logical model mapped to data in a data warehouse, by creating a simplified star schema business model over various data sources so that the user can query data as if it originated at a single source. The information can then be returned to the presentation layer as subject areas, according to business model layer mapping rules.

In accordance with an embodiment, the query engine (e.g., OBIS) can process queries against a database according to a query execution plan 56, that can include various child (leaf) nodes, generally referred to herein in various embodiments as RqLists, and produces one or more diagnostic log entries. Within a query execution plan, each execution plan component (RqList) represents a block of query in the query execution plan, and generally translates to a SELECT statement. An RqList may have nested child RqLists, similar to how a SELECT statement can select from nested SELECT statements.

In accordance with an embodiment, during operation the query engine or business intelligence server can create a query execution plan which can then be further optimized, for example to perform aggregations of data necessary to respond to a request. Data can be combined together and further calculations applied, before the results are returned to the calling application, for example via the ODBC interface.

In accordance with an embodiment, a complex, multi-pass request that requires multiple data sources may require the query engine or business intelligence server to break the query down, determine which sources, multi-pass calculations, and aggregates can be used, and generate the logical query execution plan spanning multiple databases and physical SQL statements, wherein the results can then be passed back, and further joined or aggregated by the query engine or business intelligence server.

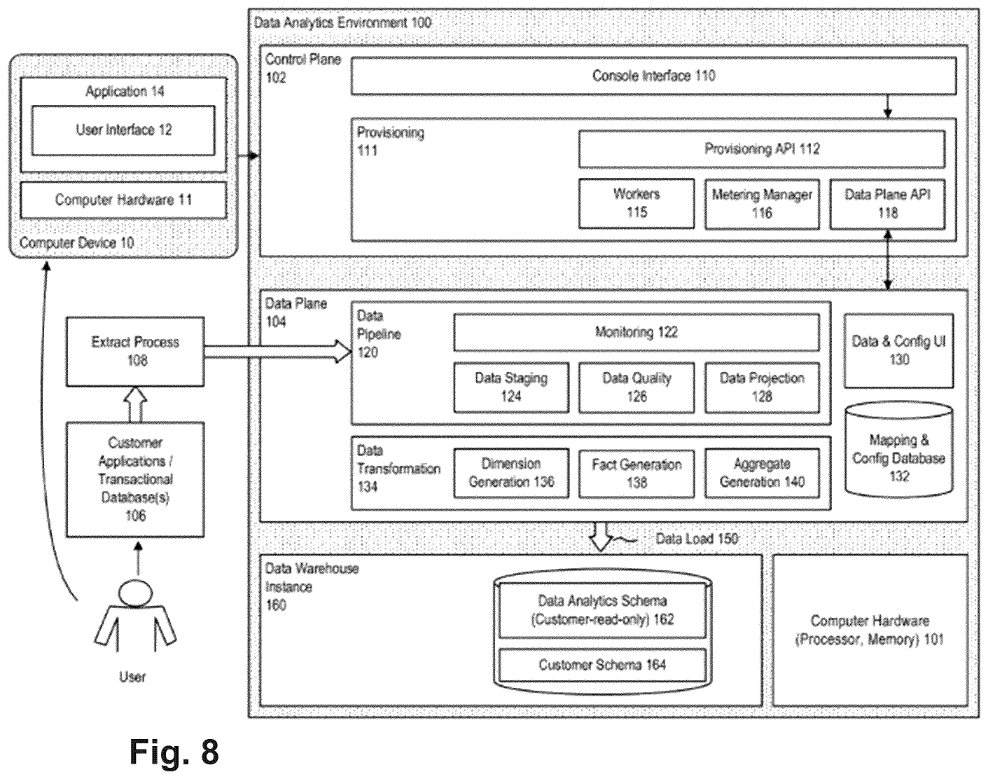

FIG. 8 further illustrates an example data analytics environment, in accordance with an embodiment. As illustrated in FIG. 8, in accordance with an embodiment, the provisioning component can also comprise a provisioning application programming interface (“API”) 112, a number of workers 115, a metering manager 116, and a data plane API 118, as further described below. The console interface can communicate, for example, by making API calls, with the provisioning API when commands, instructions, or other inputs are received at the console interface to provision services within the SaaS environment, or to make configuration changes to provisioned services.

In accordance with an embodiment, the data plane API can communicate with the data plane. For example, in accordance with an embodiment, provisioning and configuration changes directed to services provided by the data plane can be communicated to the data plane via the data plane API.

In accordance with an embodiment, the metering manager can include various functionality that meters services and usage of services provisioned through control plane. For example, in accordance with an embodiment, the metering manager can record a usage over time of processors provisioned via the control plane, for particular customers (tenants), for billing purposes. Likewise, the metering manager can record an amount of storage space of data warehouse partitioned for use by a customer of the SaaS environment, for billing purposes.

In accordance with an embodiment, the data pipeline or process, provided by the data plane, can including a monitoring component 122, a data staging component 124, a data quality component 126, and a data projection component 128, as further described below.

In accordance with an embodiment, the data transformation layer can include a dimension generation component 136, fact generation component 138, and aggregate generation component 140, as further described below. The data plane can also include a data and configuration user interface 130, and mapping and configuration database 132.

In accordance with an embodiment, the data warehouse can include a default data analytics schema (referred to herein in accordance with some embodiments as an analytic warehouse schema) 162 and, for each customer (tenant) of the system, a customer schema 164.

In accordance with an embodiment, to support multiple tenants, the system can enable the use of multiple data warehouses or data warehouse instances. For example, in accordance with an embodiment, a first warehouse customer tenancy for a first tenant can comprise a first database instance, a first staging area, and a first data warehouse instance of a plurality of data warehouses or data warehouse instances; while a second customer tenancy for a second tenant can comprise a second database instance, a second staging area, and a second data warehouse instance of the plurality of data warehouses or data warehouse instances.

In accordance with an embodiment, based on the data model defined in the mapping and configuration database, the monitoring component can determine dependencies of several different data sets to be transformed. Based on the determined dependencies, the monitoring component can determine which of several different data sets should be transformed to the model format first.

For example, in accordance with an embodiment, if a first model dataset incudes no dependencies on any other model data set; and a second model data set includes dependencies to the first model data set; then the monitoring component can determine to transform the first data set before the second data set, to accommodate the second data set's dependencies on the first data set.

For example, in accordance with an embodiment, dimensions can include categories of data such as, for example, “name,” “address,” or “age”. Fact generation includes the generation of values that data can take, or “measures.” Facts can be associated with appropriate dimensions in the data warehouse instance. Aggregate generation includes creation of data mappings which compute aggregations of the transformed data to existing data in the customer schema of data warehouse instance.

In accordance with an embodiment, once any transformations are in place (as defined by the data model), the data pipeline or process can read the source data, apply the transformation, and then push the data to the data warehouse instance.

In accordance with an embodiment, data transformations can be expressed in rules, and once the transformations take place, values can be held intermediately at the staging area, where the data quality component and data projection components can verify and check the integrity of the transformed data, prior to the data being uploaded to the customer schema at the data warehouse instance. Monitoring can be provided as the extract, transform, load process runs, for example, at a number of compute instances or virtual machines. Dependencies can also be maintained during the extract, transform, load process, and the data pipeline or process can attend to such ordering decisions.

In accordance with an embodiment, after transformation of the extracted data, the data pipeline or process can execute a warehouse load procedure, to load the transformed data into the customer schema of the data warehouse instance. Subsequent to the loading of the transformed data into customer schema, the transformed data can be analyzed and used in a variety of additional business intelligence processes.

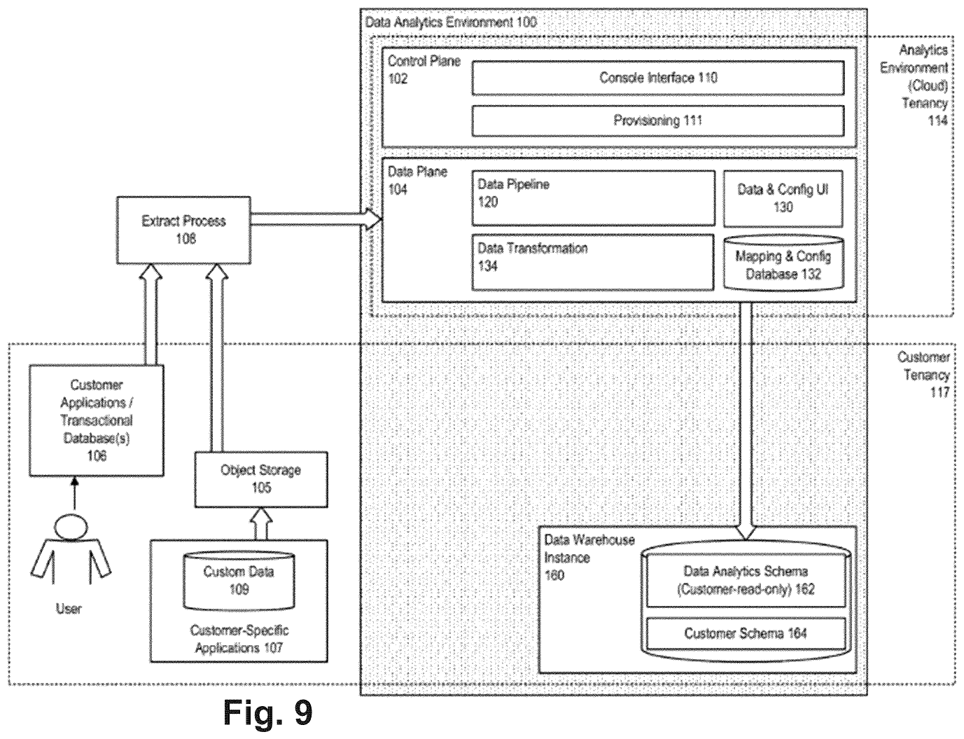

FIG. 9 further illustrates an example data analytics environment, in accordance with an embodiment. As illustrated in FIG. 9, in accordance with an embodiment, data can be sourced, e.g., from a customer's (tenant's) enterprise software application or data environment (106), using the data pipeline process; or as custom data 109 sourced from one or more customer-specific applications 107; and loaded to a data warehouse instance, including in some examples the use of an object storage 105 for storage of the data.

In accordance with embodiments of analytics environments such as, for example, Oracle Analytics Cloud (“OAC”), a user can create a data set that uses tables from different connections and schemas. The system uses the relationships defined between these tables to create relationships or joins in the data set.

In accordance with an embodiment, for each customer (tenant), the system uses the data analytics schema that is maintained and updated by the system, within a system/cloud tenancy 114, to pre-populate a data warehouse instance for the customer, based on an analysis of the data within that customer's enterprise applications environment, and within a customer tenancy 117. As such, the data analytics schema maintained by the system enables data to be retrieved, by the data pipeline or process, from the customer's environment, and loaded to the customer's data warehouse instance.

In accordance with an embodiment, the system also provides, for each customer of the environment, a customer schema that is readily modifiable by the customer, and which allows the customer to supplement and utilize the data within their own data warehouse instance. For each customer, their resultant data warehouse instance operates as a database whose contents are partly-controlled by the customer; and partly-controlled by the environment (system).

For example, in accordance with an embodiment, a data warehouse (e.g., ADW) can include a data analytics schema and, for each customer/tenant, a customer schema sourced from their enterprise software application or data environment. The data provisioned in a data warehouse tenancy (e.g., an ADW cloud tenancy) is accessible only to that tenant; while at the same time allowing access to various, e.g., ETL-related or other features of the shared environment.

In accordance with an embodiment, to support multiple customers/tenants, the system enables the use of multiple data warehouse instances; wherein for example, a first customer tenancy can comprise a first database instance, a first staging area, and a first data warehouse instance; and a second customer tenancy can comprise a second database instance, a second staging area, and a second data warehouse instance.

In accordance with an embodiment, for a particular customer/tenant, upon extraction of their data, the data pipeline or process can insert the extracted data into a data staging area for the tenant, which can act as a temporary staging area for the extracted data. A data quality component and data protection component can be used to ensure the integrity of the extracted data; for example by performing validations on the extracted data while the data is temporarily held in the data staging area. When the extract process has completed its extraction, the data transformation layer can be used to begin the transformation process, to transform the extracted data into a model format to be loaded into the customer schema of the data warehouse.

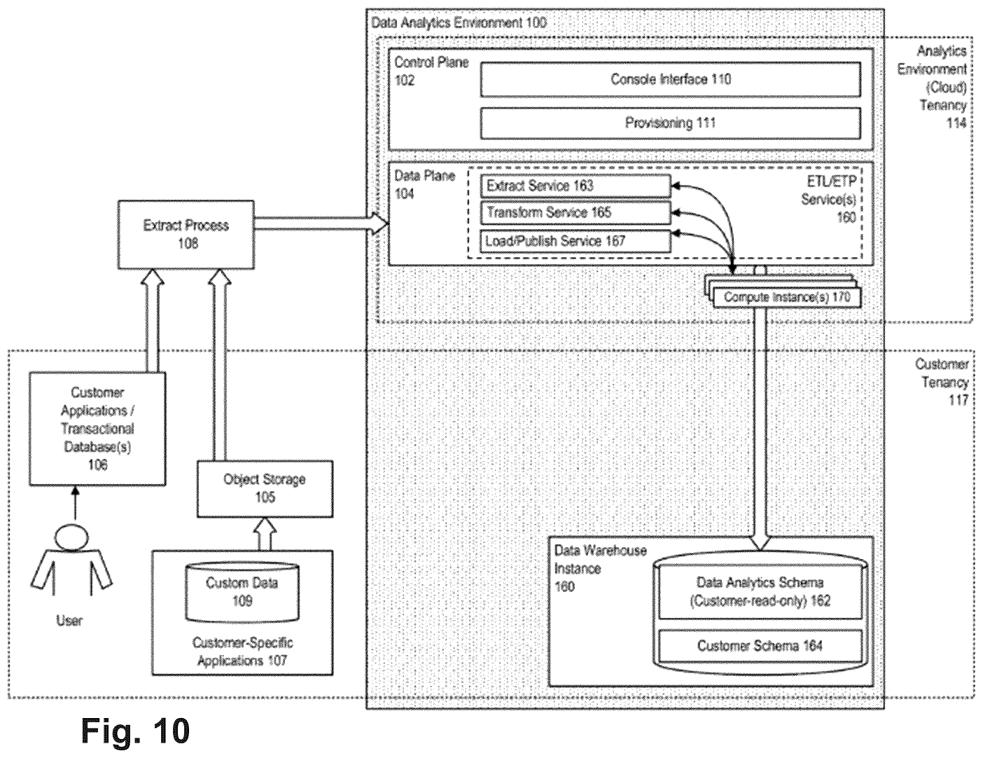

FIG. 10 further illustrates an example data analytics environment, in accordance with an embodiment. As illustrated in FIG. 10, in accordance with an embodiment, the process of extracting data, e.g., from a customer's (tenant's) enterprise software application or data environment, using the data pipeline process as described above; or as custom data sourced from one or more customer-specific applications; and loading the data to a data warehouse instance, or refreshing the data in a data warehouse, generally involves three broad stages, performed by an ETP service 160 or process, including one or more extraction service 163; transformation service 165; and load/publish service 167, executed by one or more compute instance(s) 170.

For example, in accordance with an embodiment, a list of view objects for extractions can be submitted, for example, to an Oracle BI Cloud Connector (“BICC”) component via a ReST call. The extracted files can be uploaded to an object storage component, such as, for example, an Oracle Storage Service (“OSS”) component, for storage of the data. The transformation process takes the data files from object storage component (e.g., OSS), and applies a business logic while loading them to a target data warehouse, e.g., an ADW database, which is internal to the data pipeline or process, and is not exposed to the customer (tenant). A load/publish service or process takes the data from the, e.g., ADW database or warehouse, and publishes it to a data warehouse instance that is accessible to the customer (tenant).

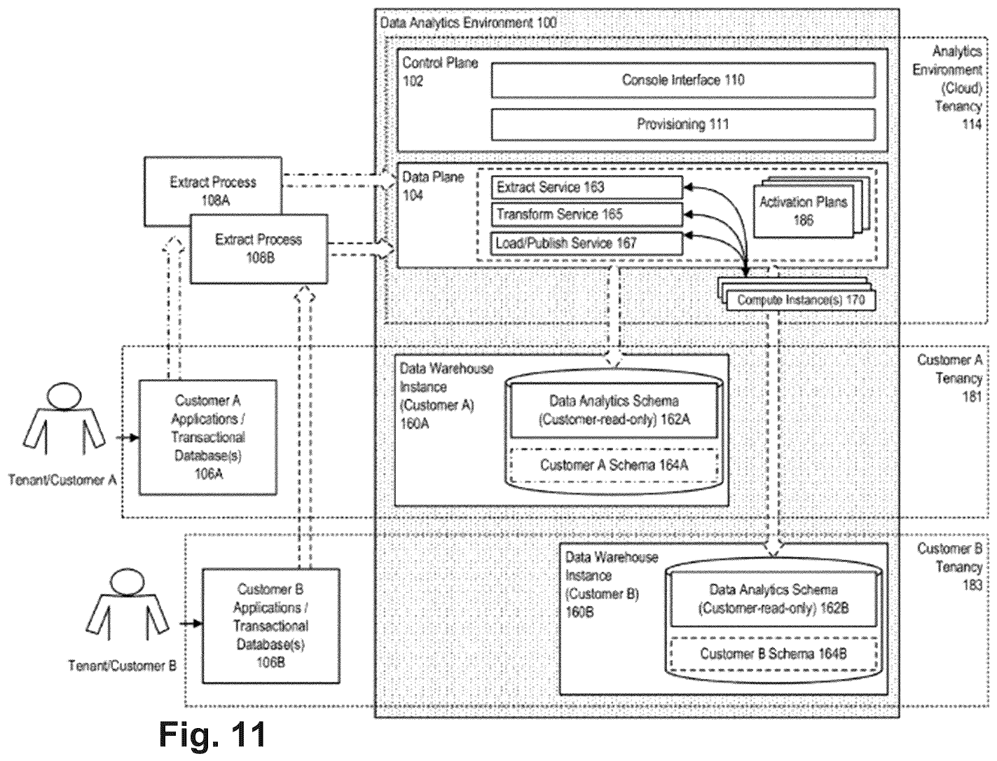

FIG. 11 further illustrates an example data analytics environment, in accordance with an embodiment. As illustrated in FIG. 11, which illustrates the operation of the system with a plurality of tenants (customers) in accordance with an embodiment, data can be sourced, e.g., from each of a plurality of customer's (tenant's) enterprise software application or data environment, using the data pipeline process as described above; and loaded to a data warehouse instance.

In accordance with an embodiment, the data pipeline or process maintains, for each of a plurality of customers (tenants), for example customer A 180, customer B 182, a data analytics schema that is updated on a periodic basis, by the system in accordance with best practices for a particular analytics use case.

In accordance with an embodiment, for each of a plurality of customers (e.g., customers A, B), the system uses the data analytics schema 162A, 162B, that is maintained and updated by the system, to pre-populate a data warehouse instance for the customer, based on an analysis of the data within that customer's enterprise applications environment 106A, 106B, and within each customer's tenancy (e.g., customer A tenancy 181, customer B tenancy 183); so that data is retrieved, by the data pipeline or process, from the customer's environment, and loaded to the customer's data warehouse instance 160A, 160B.

In accordance with an embodiment, the data analytics environment also provides, for each of a plurality of customers of the environment, a customer schema (e.g., customer A schema 164A, customer B schema 164B) that is readily modifiable by the customer, and which allows the customer to supplement and utilize the data within their own data warehouse instance.

As described above, in accordance with an embodiment, for each of a plurality of customers of the data analytics environment, their resultant data warehouse instance operates as a database whose contents are partly-controlled by the customer; and partly-controlled by the data analytics environment (system); including that their database appears pre-populated with appropriate data that has been retrieved from their enterprise applications environment to address various analytics use cases. When the extract process 108A, 108B for a particular customer has completed its extraction, the data transformation layer can be used to begin the transformation process, to transform the extracted data into a model format to be loaded into the customer schema of the data warehouse.

In accordance with an embodiment, activation plans 186 can be used to control the operation of the data pipeline or process services for a customer, for a particular functional area, to address that customer's (tenant's) particular needs.

For example, in accordance with an embodiment, an activation plan can define a number of extract, transform, and load (publish) services or steps to be run in a certain order, at a certain time of day, and within a certain window of time.

In accordance with an embodiment, each customer can be associated with their own activation plan(s). For example, an activation plan for a first Customer A can determine the tables to be retrieved from that customer's enterprise software application environment (e.g., their Fusion Applications environment), or determine how the services and their processes are to run in a sequence; while an activation plan for a second Customer B can likewise determine the tables to be retrieved from that customer's enterprise software application environment, or determine how the services and their processes are to run in a sequence.

The features, structures, or characteristics of the disclosure described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present disclosure. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the embodiments as discussed above may be practiced with steps in a different order, and/or with elements in configurations that are different than those which are disclosed. Therefore, although this disclosure considers the outlined embodiments, it would be apparent to those of skill in the art that certain modifications, variations, and alternative constructions would be apparent, while remaining within the spirit and scope of this disclosure. In order to determine the metes and bounds of the disclosure, therefore, reference should be made to the appended claims.

What is claimed is:

1. A method of classifying a product to one of a plurality of product classifications, the method comprising:
receiving a description of the product;
creating a first prompt for a trained large language model (LLM), the first prompt comprising the description of the product and contextual information of the product;
in response to the first prompt, using the trained LLM to generate a hallucinated product classification for the product;
word embedding the hallucinated product classification and the plurality of product classifications; and
similarity matching the embedded hallucinated product classification with one of the embedded plurality of product classifications, wherein the matched one of the embedded plurality of product classifications is determined to be a predicted classification of the product.

2. The method of claim 1, wherein the word embedding comprises converting a word into a vector.

3. The method of claim 1, wherein the description of the product is extracted from a product database.

4. The method of claim 3, wherein the description of the product comprises one or more of price, enterprise details, department purchasing the product, manufacturer name or country of manufacture.

5. The method of claim 1, wherein the product classifications each comprise a family, a class and a category.

6. The method of claim 1, further comprising:
for each of the plurality of product classifications, using a second trained LLM to generate a plurality of corresponding products;
wherein the word embedding further comprises word embedding each of the plurality of corresponding products.

7. The method of claim 1, wherein the word embedding is executed using a plurality of different word embedding encodings, each different word embedding encoding stored in a corresponding separate vector store.

8. The method of claim 1, further comprising:
generating a second prompt for using the trained LLM to generate an industry name that corresponds to a name of a company that purchased the product; or
generating a third prompt for using the trained LLM to generate an industry name that corresponds to a list of products the company has purchased.

9. A computer readable medium having instructions stored thereon that, when executed by one or more processors, cause the processors to classify a product to one of a plurality of product classifications, the classifying comprising:
receiving a description of the product;
creating a first prompt for a trained large language model (LLM), the first prompt comprising the description of the product and contextual information of the product;
in response to the first prompt, using the trained LLM to generate a hallucinated product classification for the product;
word embedding the hallucinated product classification and the plurality of product classifications; and
similarity matching the embedded hallucinated product classification with one of the embedded plurality of product classifications, wherein the matched one of the embedded plurality of product classifications is determined to be a predicted classification of the product.

10. The computer readable medium of claim 9, wherein the word embedding comprises converting a word into a vector.

11. The computer readable medium of claim 9, wherein the description of the product is extracted from a product database.

12. The computer readable medium of claim 11, wherein the description of the product comprises one or more of price, enterprise details, department purchasing the product, manufacturer name or country of manufacture.

13. The computer readable medium of claim 9, wherein the product classifications each comprise a family, a class and a category.

14. The computer readable medium of claim 9, the classifying further comprising:
for each of the plurality of product classifications, using a second trained LLM to generate a plurality of corresponding products;
wherein the word embedding further comprises word embedding each of the plurality of corresponding products.

15. The computer readable medium of claim 9, wherein the word embedding is executed using a plurality of different word embedding encodings, each different word embedding encoding stored in a corresponding separate vector store.

16. The computer readable medium of claim 9, the classifying further comprising:
generating a second prompt for using the trained LLM to generate an industry name that corresponds to a name of a company that purchased the product; or
generating a third prompt for using the trained LLM to generate an industry name that corresponds to a list of products the company has purchased.

17. A spend classification system comprising:
a product description database;
a trained large language model (LLM);
one or more processors coupled to the database and LLM and configured to classify a product to one of a plurality of product classifications, the classifying comprising:
receiving a description of the product from the database;
creating a first prompt for the LLM, the first prompt comprising the description of the product and contextual information of the product;
in response to the first prompt, using the trained LLM to generate a hallucinated product classification for the product;
word embedding the hallucinated product classification and the plurality of product classifications; and
similarity matching the embedded hallucinated product classification with one of the embedded plurality of product classifications, wherein the matched one of the embedded plurality of product classifications is determined to be a predicted classification of the product.

18. The spend classification system of claim 17, wherein the word embedding comprises converting a word into a vector.

19. The spend classification system of claim 17, wherein the description of the product comprises one or more of price, enterprise details, department purchasing the product, manufacturer name or country of manufacture.

20. The spend classification system of claim 17, wherein the product classifications each comprise a family, a class and a category.
